(19) United States
(12) Patent Application Publication
(10) Pub. No.: US 2025/0292346 A1
(43) Pub. Date: Sep. 18, 2025

(54) SYSTEM AND METHOD FOR PERSONALIZED RIDE-SHARING WITH REAL-TIME DRIVER SELECTION AND CASHLESS PAYMENT

(71) Applicant: Anthony Austin, Milwaukee, WI (US)

(72) Inventor: Anthony Austin, Milwaukee, WI (US)

(21) Appl. No.: 19/052,994

(22) Filed: Feb. 13, 2025

Related U.S. Application Data
(60) Provisional application No. 63/565,579, filed on Mar. 15, 2024.

(51) Int. Cl. G06Q 50/47; G06Q 20/02; G06Q 20/32; G06Q 30/0282

(52) U.S. Cl. CPC G06Q 50/47; G06Q 20/027; G06Q 20/3274; G06Q 30/0282

(57) ABSTRACT

The present invention relates to a ride-sharing system which includes two mobile applications: a driver application and a rider application, operating in conjunction with a central server system. The driver application allows drivers to create detailed profiles including credentials, vehicle information, and payment options, and generates a scannable QR code for secure and cashless payments. The rider application enables riders to search for drivers, view profiles, select a preferred driver, book rides, and process payments using the driver's QR code. The server system comprises a driver profile database, a rider profile database, a payment module, and a location module for real-time tracking and matching of drivers and riders. The method of ride booking includes steps for profile setup, ride booking, real-time ride management, and secure payment processing, providing an efficient, safe, and personalized ride-sharing experience.

### CROSS-REFERENCE TO RELATED APPLICATION

The present application claims priority to, and the benefit of, U.S. Provisional Application No. 63/565,579, which was filed on Mar. 15, 2024, and is incorporated herein by reference in its entirety.

### FIELD OF THE INVENTION

The present invention generally relates to the field of ridesharing and transportation services. More specifically, the present invention pertains to a ride-sharing system comprising dedicated driver and rider applications for facilitating personalized ride bookings and secure cashless payments. The system includes a driver application for creating and managing driver profiles and a rider application for selecting drivers based on preferences. A central server system comprises a driver profile database, a rider profile database, a payment module, and a location module. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, ride-sharing platforms, both software applications and websites, are popular among people as convenient modes of transportation for both short and long distances. However, such conventional platforms and systems have several inherent drawbacks that affect both drivers and customers. One of the primary issues is the lack of fair compensation for drivers. Many ride-sharing services take a substantial percentage of each fare and deposit ride money in their internal accounts first which significantly reduces the income of drivers. Moreover, drivers are often left to bear operational expenses, such as gas, vehicle maintenance, insurance, and other fees, without proper reimbursement.

From the customer's perspective, current ride-sharing services present challenges regarding reliability and pricing. Riders frequently have little control over driver selection, resulting in a gamble on the driver's experience and professionalism. In some cases, riders may experience cancellations if the driver does not show up, leaving them stranded and delaying their plans. Additionally, customers are often subject to elevated fees during peak hours or high-demand periods, commonly known as “surge pricing.” There is a need in the existing market for a ride-sharing system that provides fairer compensation to drivers, enhances customer satisfaction through personalized driver selection, and streamlines payment processes.

Therefore, there exists a long-felt need in the art for a ride-sharing system that provides a more equitable compensation model for drivers. Additionally, there is a long-felt need in the art for a platform that allows drivers to market their services effectively and build a loyal customer base, leading to more consistent and reliable income. Moreover, there is a long-felt need for a ride-sharing system that empowers riders to select their preferred drivers based on specific criteria such as ratings, vehicle type, or past experiences. Furthermore, there is a need for a system that reduces rider frustration caused by unpredictable surge pricing during peak hours, thereby ensuring a fair and transparent pricing model. Finally, there is a long-felt need in the art for a ride-share software application that increases profits for drivers, eliminates poor drivers, and allows riders to choose drivers.

The subject matter disclosed and claimed herein, in one embodiment thereof, comprises a ride-sharing system with dedicated driver and rider mobile applications that operate in conjunction with a central server system. The driver application is installed on the driver's device, enabling drivers to create detailed profiles including personal information, vehicle specifications, driving experience, and payment options. It also generates a scannable QR code for cashless transactions. The rider application, installed on the rider's device, allows riders to search for available drivers, view detailed profiles, select a driver, initiate ride requests, and complete payments securely using the driver's QR code. The central server system includes a driver profile database for storing driver profiles, a rider profile database for managing rider information and bookings, a payment module for processing transactions using blockchain technology, and a location module for real-time tracking and driver-rider matching.

In this manner, the ride-sharing system of the present invention accomplishes all of the foregoing objectives and offers a comprehensive solution to current industry challenges. The server system's payment module provides secure, cashless transactions and the location module enables efficient real-time ride matching. The system allows drivers to share a QR code with passengers and book more jobs instead of relying on random clients. The system includes a review system for clients so they can quickly eliminate poor drivers that do not show up on time. The dynamic interaction between the driver and rider applications and the central server ensures fair compensation for drivers, improved reliability for riders, and an overall streamlined, user-friendly ride-sharing platform.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a ride-sharing system. The system comprises a driver application configured to be installed on a first user device, wherein the driver application enables drivers to create a profile including personal details, driving experience, vehicle specifications, and payment information, and generates a scannable code for cashless payments. A rider application is configured to be installed on a second user device, wherein the rider application enables riders to search for drivers, view driver profiles, select a driver based on preferences, initiate ride requests, and make payments through the scannable code generated by the driver application. A server system in communication with the driver application and the rider application via a communication network, the server system comprises a driver profile database, a rider profile database, and a payment module, wherein upon initiation of a ride request by the rider application, the server system identifies a selected driver, processes the ride request, sends a notification to the driver application, and updates the booking status based on the driver's acceptance or rejection.

In yet another embodiment, a ride-booking system is described. The system includes a driver mobile application to enable drivers to create and update profiles showcasing their credentials, vehicle details, and payment options, automatically generate a QR code linked to the driver's payment system for cashless transactions, receive ride requests, and display booking notifications for acceptance or rejection. A rider mobile application allows riders to search for available drivers, view detailed driver profiles, select a driver based on personal preferences, and mark drivers as favorites for quicker future bookings and initiate ride requests, and facilitate payments through the scanning of the driver's QR code. A server is configured to process ride requests, track ride status, and manage payments and reviews through an integrated client-server architecture.

In another aspect, a method for managing ridesharing using a ride-sharing system comprising a driver application, a rider application, and a server system is described. The method includes the steps of receiving, through the driver application installed on a first user device, driver profile information including personal details, driving experience, vehicle specifications, and payment options. Generating, via the driver application, a scannable QR code linked to the driver's payment system for cashless payments. Storing the driver's profile information in a driver profile database managed by the server system. Receiving, through the rider application installed on a second user device, a ride request initiated by a rider after selecting a driver from a list of available drivers displayed on the rider application. Processing, by the server system, the ride request by identifying the selected driver using stored driver profile information and sending a notification to the driver application. Updating, by the server system, the ride-booking status based on the driver's acceptance or rejection of the ride request. Facilitating payment upon ride completion by scanning the driver's QR code through the rider application.

In still another aspect, a method for booking rides using a ride-sharing system is described. The method includes the steps of receiving, through a rider mobile application installed on a rider's device, a search query for available drivers in the rider's vicinity, displaying, on the rider mobile application, a list of available drivers including driver profiles, ratings, reviews, and vehicle details, enabling the rider to select a driver from the list based on preferences and initiating a ride request through the rider mobile application, sending the ride request to a central server, wherein the server identifies the selected driver using stored profile information and real-time location data, sending a booking notification from the server to a driver mobile application installed on the driver's device for acceptance or rejection of the ride request, and facilitating secure cashless payment after ride completion using a scannable QR code generated by the driver application and processed through a payment module on the server.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of the ride-sharing application system of the present invention in accordance with the disclosed structure;

FIG. 2 illustrates a flow chart depicting a process of driver profile set up using the driver application in accordance with the disclosed architecture;

FIG. 3 illustrates a flow chart depicting a process of ride-booking using the ride-booking system of the present invention in accordance with the disclosed structure;

FIG. 4 illustrates an exemplary interface displayed by the driver application of the present invention for generating a QR code in accordance with the disclosed structure; and

FIG. 5 illustrates a user interface displayed by the rider application displaying a list of drivers for selection for a ride in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a ride-sharing system that provides a more equitable compensation model for drivers. Additionally, there is a long-felt need in the art for a platform that allows drivers to market their services effectively and build a loyal customer base, leading to more consistent and reliable income. Moreover, there is a long-felt need for a ride-sharing system that empowers riders to select their preferred drivers based on specific criteria such as ratings, vehicle type, or past experiences. Furthermore, there is a need for a system that reduces rider frustration caused by unpredictable surge pricing during peak hours, thereby ensuring a fair and transparent pricing model. Finally, there is a long-felt need in the art for a ride-share software application that increases profits for drivers, eliminates poor drivers, and allows riders to choose drivers.

The present invention, in one exemplary embodiment, is a method for booking rides using a ride-sharing system. The method includes the steps of receiving, through a rider mobile application installed on a rider's device, a search query for available drivers in the rider's vicinity, displaying, on the rider mobile application, a list of available drivers including driver profiles, ratings, reviews, and vehicle details, enabling the rider to select a driver from the list based on preferences and initiating a ride request through the rider mobile application, sending the ride request to a central server, wherein the server identifies the selected driver using stored profile information and real-time location data, sending a booking notification from the server to a driver mobile application installed on the driver's device for acceptance or rejection of the ride request, and facilitating secure cashless payment after ride completion using a scannable QR code generated by the driver application and processed through a payment module on the server.

Reference will now be made in detail to the present preferred embodiments of the invention, examples of which are illustrated in the accompanying drawings. Wherever possible, the same reference numerals are used in the drawings and the description to refer to the same or like parts.

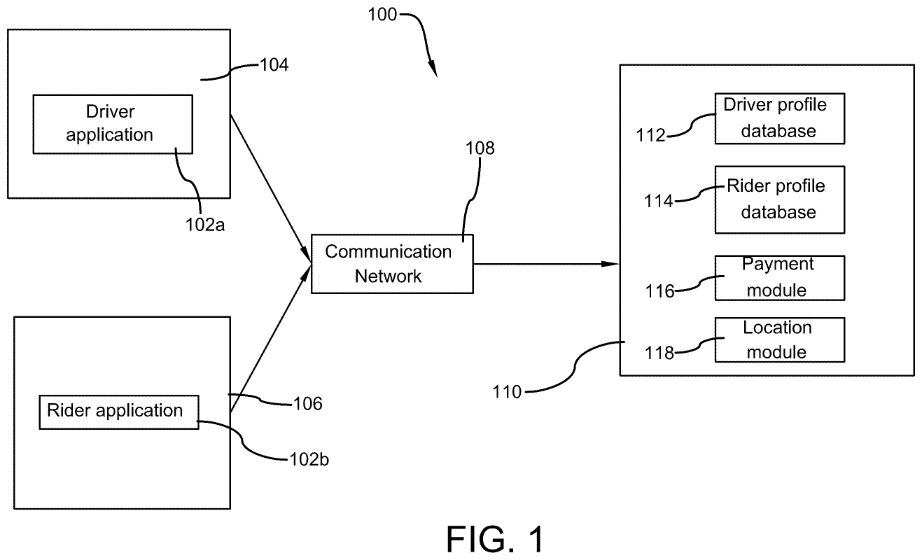

Referring initially to the drawings, FIG. 1 illustrates a schematic view of the ride-sharing application system of the present invention in accordance with the disclosed structure. The system 100 of the present invention is designed to connect riders and drivers more efficiently and safely through two dedicated mobile applications: one for drivers and one for riders. More specifically, the system 100 includes a driver application 102a which is adapted to be installed on a user device 104 such as a smartphone, tablet, or any other similar device. The driver application 102a is used by drivers to create a profiles, showcasing their experience, ratings, and other credentials. The drivers receive ride notifications from potential riders wanting a ride via the driver application 102a.

A rider application 102b is installed on a user device 106 (such as but not limited to a smartphone, tablet, etc.) and is used by riders to search for available drivers in their area. The riders can view driver profiles and select a driver, thereby providing them with control over their ride experience. It will be apparent to a person skilled in the art that the applications 102a, 102b are two different versions of the same application and are configured to provide different functionalities to the drivers and riders. The rider application 102b can also be used to book rides, make payments, and leave feedback.

The applications 102a,102b are configured to provide functionalities offered by a server system 110. The applications 102a, 102b access the functionalities using the communication network 108. The server 110 includes a driver profile database 112 for storing and managing at least one driver profile. When a new driver registers in the system 100, the profile of the driver is stored in the driver profile database 112. The database 112 also stores feedback and payment information of the drivers. A rider profile database 114 is adapted to store and manage rider profiles. The rider bookings, payment information, personal details, and more are stored in the rider profile database 114.

A payment module 116 manages payments made by the riders and received by the drivers. All the payment information stored in the databases 112,114 are used by the module 116 for automatic processing of payments. The payment module 116 may use or be comprised of a payment gateway for facilitating the payments between the riders and the drivers. A location module 118 is configured to track the real-time locations of different vehicles of the drivers registered in the system 100. The location module 118 is also used for the automatic matching of a driver for a rider. When a rider selects a driver on the rider app 102b and initiates a booking, the rider app 102b sends a ride request to the server 110. The server 110 processes the request, identifies the selected driver using the driver profile and location module 118, and sends a notification to the driver app 102a, wherein the driver can then accept or decline the ride. The response is sent back to the server 110, which updates the booking status and informs the rider of the driver's acceptance or rejection.

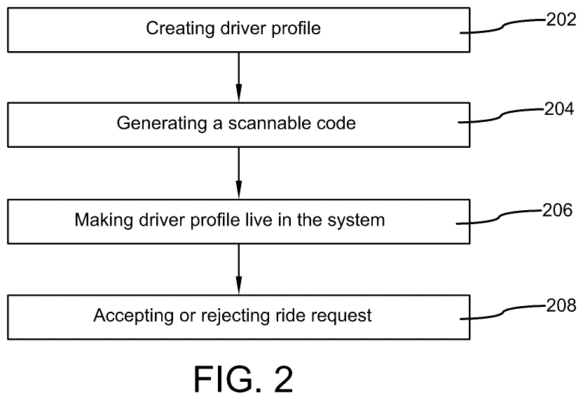

FIG. 2 illustrates a flow chart depicting a process of driver profile set up using the driver application in accordance with the disclosed architecture. Initially, a driver downloads the driver application 102a and creates a profile by providing personal details such as name, age, gender, SSN, and more (Step 202). The driver also provides driving experience, vehicle specifications, and payment details. Then, a scannable code such as a QR code is generated by the driver using the application 102a for receiving the cashless payments (Step 204). Thereafter, the driver's profile is approved by the system 100 and the profile of the driver is visible to the riders (Step 206). In case the profile of a driver is not approved, the driver is not registered in the system 100 and may not use functionalities offered by the system 100. When a ride request from a rider is received on the driver application 102a, the driver can review the request and can choose to accept or decline the ride request (Step 208). When a driver declines a ride request, the ride request of the rider can be redirected to other drivers in the area of the rider.

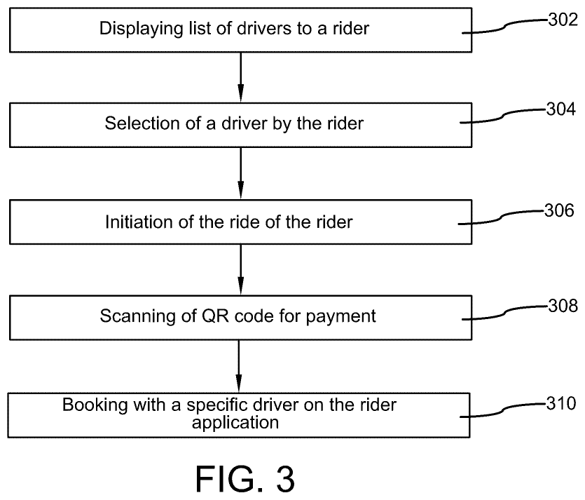

FIG. 3 illustrates a flow chart depicting a process of ride-booking using the ride-booking system of the present invention in accordance with the disclosed structure. Initially, a rider searches for available drivers in their vicinity in the rider app 102b wherein the app 102b displays a list of drivers, complete with profiles, ratings, reviews, and vehicle details (Step 302). Then, the rider selects a driver based on their preferences and initiates a ride request (Step 304). Once the ride request is accepted by a driver, the applications 102a, 102b facilitate the journey, providing navigation, communication, and real-time tracking (Step 306). After the ride, the rider scans the QR code of the driver which links to the driver's payment system and the rider can complete the transaction securely (Step 308). For future bookings, the rider can search for specific drivers using the rider App 102b to re-book the drivers they had positive experiences with earlier (Step 310). The rider can mark drivers as favorites, enabling quicker bookings in the future.

It should be noted that unlike conventional ride-sharing services that assign drivers randomly, the myride system 100 of the present invention enables riders to choose their preferred driver, improving satisfaction and safety. A QR code-based payment system enhances transaction security and simplifies the payment process. The QR code can be displayed on the rider app 102b during a ride for making payment easily by a rider. Further, riders have the flexibility to choose drivers based on personal preferences, vehicle types, and ratings, ensuring a tailored ride-sharing experience.

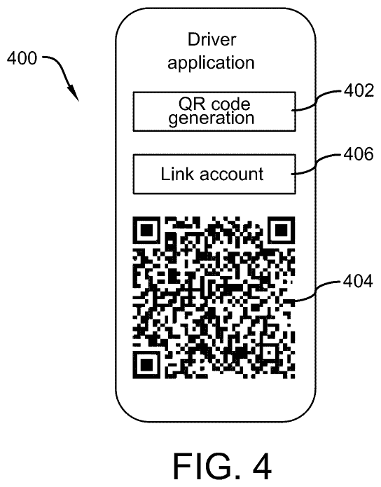

FIG. 4 illustrates an exemplary interface displayed by the driver application of the present invention for generating a QR code in accordance with the disclosed structure. The interface 400 is displayed to a driver for generating the scannable computer-readable code 404 for receiving payment from a rider. A QR generation option 402 is selected for an automatic QR code generation wherein the QR code 404 is automatically shared with a rider when the rider selects the driver for a ride. The system 100 will calculate the trip cost as soon as the rider enters the pickup address and destination in the app 102b. Accordingly, the QR code 404 is generated as soon as the driver accepts the ride, and the rider must make payment prior to the ride start, either through their rider mobile application 102b or by scanning the QR code 404 on the driver's smart device once they are in the vehicle, but still before the trip begins. In the event the rider chooses to pay with cash, they can do so once the driver has arrived but, again, still prior to the trip's start. Drivers will have the ability to enable or disable the acceptance of cash payments within the application 102a. The QR code 404 can be connected to one or more payment accounts of the driver using the “Link Account” 406 option, allowing the driver to select the account for receiving payments. Payments made by riders using the QR code 404 are settled in the selected payment account of the driver, and the system 100 logs the payments received by a driver.

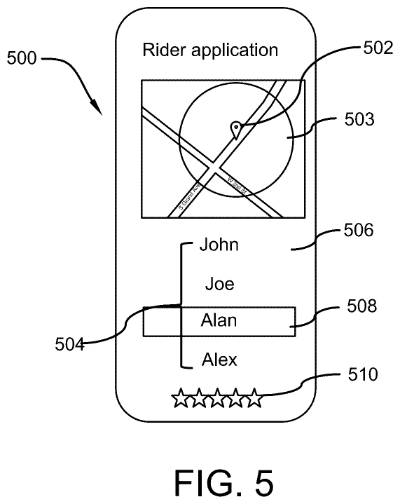

FIG. 5 illustrates a user interface displayed by the rider application displaying a list of drivers for selection for a ride in accordance with the disclosed architecture. The interface 500 displays the current location 502 of the rider on a map 503 or alternatively in a text form and a list 504 of nearby riders is displayed on the interface 500. A driver with whom the rider has taken a ride earlier is highlighted in a first highlight 506 and a driver who has been marked as a favorite 508 is also highlighted in the list. The list helps the rider to re-book the ride with a preferred driver. In one embodiment, a rider can blacklist one or more drivers and such drivers are not recommended or matched by the system for the rider, thereby enhancing the safety of the rider. The interface 500 also allows the rider to provide a feedback or rating using rating option 510 for a driver with whom an earlier ride was booked by the rider. The feedback ensures that poor drivers who do not show up on time can be eliminated from the system. In one embodiment, drivers can also provide a review of the riders, thereby enhancing the experience of the drivers as well. The rider's ratings are visible to the driver selected by the rider and accordingly, the driver can reject or accept the ride request.

The integrated ride-sharing platform 100 considers rider preferences (e.g., gender, vehicle type, driver rating), driver history, traffic patterns, and real-time location data for predicting the best driver for each rider. A rider can also earn loyalty points or reward points for using specific drivers which can be redeemed for discounts and upgrades. The reward points can be automatically generated by the system based on the rating of drivers and can also be preset by the driver for increasing business.

In one embodiment of the present invention, the system 100 uses blockchain technology for handling payments, ensuring transparent and secure transactions. Every ride payment is recorded as a blockchain transaction, reducing fraud and enabling verifiable, tamper-proof payment records.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “integrated ride-sharing platform”, “ride-sharing application system”, “personalized ride-sharing system”, and “system” are interchangeable and refer to the system and method for personalized ridesharing with real-time driver selection 100 of the present invention.

Notwithstanding the forgoing, the system and method for personalized ridesharing with real-time driver selection 100 of the present invention can be of any suitable size and configuration as is known in the art without affecting the overall concept of the invention, provided that it accomplishes the above stated objectives. One of ordinary skill in the art will appreciate that the system and method for personalized ridesharing with real-time driver selection 100 as shown in the FIGS. are for illustrative purposes only, and that many other configurations of the system and method for personalized ridesharing with real-time driver selection 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ride-sharing application system comprising:
a driver application configured to allow a driver to create a driver profile, receive a ride requests from a rider, and generate a scannable code for receiving a payment;
a rider application configured to allow a rider to view the driver profile, select the driver, initiate the ride request, and make the payment by scanning the scannable code generated by the driver application; and
a server system communicatively coupled to the driver application and the rider application, the server system configured to store and manage the driver profile and a rider profile, process the ride request, and facilitate the payment between the rider and the driver.

2. The ride-sharing application system of claim 1, wherein the drive profile is comprised of a driver rating, a vehicle detail, and a rider feedback.

3. The ride-sharing application system of claim 1 further comprising a location module configured to track a real-time location of a driver and facilitate automatic matching of a driver and a rider based on proximity.

4. The ride-sharing application system of claim 1, wherein the rider application allows the rider to mark a driver as a favorite and re-book the driver.

5. The ride-sharing application system of claim 1, wherein the driver application and the rider application are configured to provide a real-time navigation and a communication between the driver and rider during a ride.

6. The ride-sharing application system of claim 1, wherein the server system is configured to store a ride history.

7. A ride-sharing application system comprising:
a driver application configured to allow the driver to create a profile, receive a ride notification from a rider, and generate a QR code for receiving a payment;
a rider application configured to allow the rider to search for a driver, select a driver, initiate a ride request, and complete a payment by scanning the QR code;
a server system comprising a driver profile database for storing a driver profile, a rider profile database for storing a rider profile, and a payment module for processing the payment between the rider and driver; and
a communication network enabling the driver and rider applications to access functionalities provided by the server system, wherein the server system processes the ride request and facilitates a communication between the driver application and the rider application.

8. The ride-sharing application system of claim 7, wherein the payment module is comprised of a payment gateway.

9. The ride-sharing application system of claim 7 further comprised of a location module that tracks a real-time location of the driver.

10. The ride-sharing application system of claim 7, wherein the rider application allows the rider to provide a feedback and a rating for the drivers after completing a ride.

11. The ride-sharing application system of claim 7 further comprised of a loyalty point module allowing the rider to accumulate a reward point based on a ride usage and a driver rating.

12. The ride-sharing application system of claim 7, wherein the communication network is comprised of a wireless network.

13. The ride-sharing application system of claim 7, wherein the rider application allows the rider to re-book a previously used driver.

14. The ride-sharing application system of claim 7, wherein the QR code generated by the driver application is automatically shared with the rider upon a booking.

15. A ride-sharing application system comprising:
a driver application configured to allow a driver to create a driver profile, receive a ride requests from a rider, and generate a QR code linked to a payment account;
a rider application configured to allow the rider to search for the driver, select the driver, initiate the ride request, and scan the QR code to complete a payment;
a server system configured to store driver profile and a rider profile, process the ride request, manage the payment, and track a vehicle location; and
a payment module for facilitating a cashless transaction between the rider and driver through the QR code.

16. The ride-sharing application system of claim 15, wherein the server system updates a ride booking status after the driver accepts or declines the ride request.

17. The ride-sharing application system of claim 15, wherein the server system is configured to analyze a rider preference to recommend a driver that matches a rider's criteria.

18. The ride-sharing application system of claim 15, wherein the rider preference is comprised of a preferred vehicle type.

19. The ride-sharing application system of claim 15, wherein the rider preference is comprised of a driver gender.

20. The ride-sharing application system of claim 15, wherein the payment module allows a user to split a payment.
